(19) United States
(12) Patent Application Publication
(10) Pub. No.: US 2025/0388465 A1
(43) Pub. Date: Dec. 25, 2025

(54) Production of Diborane

(71) Applicant: Messer Industries USA, Inc., Bridgewater, NJ (US)

(72) Inventor: Daniel Joseph Tempel, Easton, PA (US)

(73) Assignee: Messer Industries USA, Inc., Bridgewater, NJ (US)

(21) Appl. No.: 18/749,568

(22) Filed: Jun. 20, 2024

(51) Int. Cl. C01B 6/10

(52) U.S. Cl. CPC C01B 6/10

(57) ABSTRACT

A process for producing diborane is provided which includes mixing boron halide with borohydride ionic liquid for providing a liquid reaction mixture, the liquid reaction mixture chemically reacting for producing gaseous diborane. There is also provided a related composition for producing diborane which includes boron halide and borohydride ionic liquid. Solvents are not needed in the mixture or in the composition to produce the diborane.

### BACKGROUND OF THE INVENTION

The present embodiments relate to apparatus and methods for producing diborane to be used in the semiconductor industry and for other electronic applications.

Diborane is a gaseous chemical compound (B₂H₆) manufactured commercially for use in, for example, organic synthesis, hydrogen storage, and as a precursor for semiconductor manufacturing. In many applications, diborane is isolated as a borane (BH₃) adduct of, for example, tetrahydrofuran, dimethylsulfide, or an amine.

For semiconductor applications, however, diborane is more commonly used as a dilute mixture in hydrogen, nitrogen, argon or helium. Diborane used in hydrogen, for example, is for selectively incorporating impurities (doping boron atoms) into a silicon lattice of an intrinsic (pure) semiconductor to modulate its electrical, optical, and structural properties. Diborane diluted in nitrogen is a reducing agent for tungsten hexafluoride (WF₆) to facilitate the deposition of elemental tungsten with low resistivity to make connections between conductive components used, for example, on semiconductor chips.

Diborane is also used as an impurity, i.e., as a dopant, for deposition of amorphous carbon hard masks which are used to make printed circuits during and for the fabrication of a semiconductor. This process is known as lithography.

An early essentially quantitative process for preparing diborane was developed using lithium hydride to reduce boron trifluoride in diethyl ether:

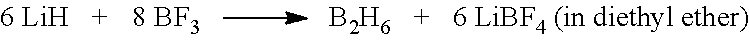

Researchers determined that this process generates lithium borohydride, LiBH₄ (metal hydride), as an intermediate. This intermediate is soluble in diethyl ether and reacts rapidly with BF₃ (boron halide) to liberate diborane. The process was improved by using LiBH₄ directly:

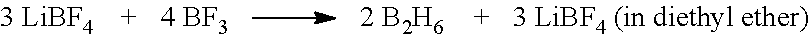

Subsequent research demonstrated that a range of metal hydrides and boron halides can be substituted into the above reaction. For example, NaBH₄, KBH₄, and LiAlH₄ can be substituted for LiBH₄; while BCI₃ and BBr₃ can be substituted for BF₃.

However, known production of diborane requires a solid constituent and the use of a solvent during the diborane production. Unfortunately, use of a solvent requires additional supervision, equipment and handling, as well as increased safety and regulatory control. These additional requirements result in increased production costs to produce the diborane and to dispose of or recycle any excess solvent.

The known, preferred method to produce diborane is the reaction of sodium borohydride and boron trifluoride in diethylene glycol dimethyl ether (diglyme):

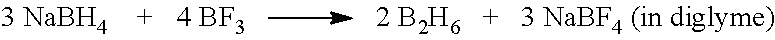

The known process steps are as follows: 1) gaseous BF₃ is passed into a solution consisting of solid NaBH₄ and a diglyme solvent, 2) to minimize thermal decomposition of the diborane, the temperature of the reaction mixture is maintained at 35° C. (95° F.) by cooling and by adjusting the rate of addition, 3) the diborane is passed into a refrigerated condenser where it is liquefied and transferred to gas cylinders for processing or storage, and 4) the slurry of sodium tetrafluoroborate, NaBF₄, is filtered and the diglyme filtrate is recycled or disposed.

One of the major gas phase impurities for this known process is dimethyl ether, which has been determined to result from decomposition of diglyme solvent through its reaction with BF₃.

Known processes also have the disadvantage of processing a solid byproduct. For example, the byproduct of the reaction of NaBH₄ with BF₃ is a solid salt, NaBF₄. When this process is carried out in a solvent, this salt is normally transferred as a slurry from the reactor; the salt being filtered away for disposal from the rest of the reaction mixture. Transferring solids or slurries creates potential issues with contamination and blockage of transfer lines and other process components. Solids make it more difficult and less efficient to carry out continuous or on-demand processes such as continuous stirred tank reactions, plug flow reactions, and microreactor flow reactions.

Another known, convenient method for the small-scale generation of B₂H₆ is the general reaction between an alkali metal borohydride, [M]BH₄, and a protic acid, H [A], as shown below:

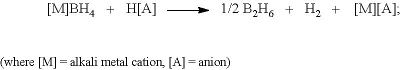

The borohydride reactant, [M]BH₄, is typically either sodium or potassium borohydride. The acid, H [A], can be selected from any number of protic acids, including sulfuric acid, methanesulfonic acid, phosphoric acids, hydrogen chloride, carboxylic acids, fluorinated acids, and other mineral and organic acids. A representative combination of reactants for generating diborane using the protic acid route is potassium borohydride and 85% orthophosphoric acid:

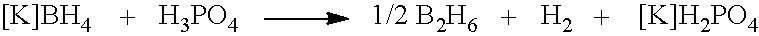

The known, protic acid method also suffers from the same disadvantages as the preferred known method using BF₃ described previously. Namely, the borohydride reagents disclosed in the known processes include solid alkali metal salts, and the byproducts are also alkali metal salts that are typically solids that have little or no solubility in organic solvents.

### SUMMARY OF THE INVENTION

Accordingly, there is provided herein embodiments for producing diborane without the use of solvents and solid constituents, and which avoid solid byproducts, which embodiments include:

A process embodiment for producing diborane consisting of mixing boron halide with borohydride ionic liquid for providing a liquid reaction mixture, the liquid reaction mixture chemically reacting for producing gaseous diborane.

A process embodiment for producing diborane consisting of mixing protic acid with borohydride ionic liquid for providing a liquid reaction mixture, the liquid reaction mixture chemically reacting for producing gaseous diborane.

A composition embodiment for producing diborane consisting of boron halide and borohydride ionic liquid.

A composition embodiment for producing diborane consisting of liquid boron halide adduct and borohydride ionic liquid.

A composition embodiment for producing diborane consisting of protic acid and borohydride ionic liquid.

The advantages of various embodiments called for herein include one or more of: 1) avoiding the use and expense of solvents, such as for example, the ether solvents used in known processes, 2) avoiding the cost of separating the diborane product from the ether solvent, 3) avoiding contamination from the degradation of ether solvents, 4) avoiding the generation of solid byproducts, and 5) improving processability by using liquid or low melting borohydride salts.

### BRIEF DESCRIPTION OF THE DRAWINGS

For a more complete understanding of the present invention, reference may be made to the following description of exemplary embodiments considered in connection with the accompanying drawing Figures, of which:

FIG. 1 is a schematic view of a system for process and composition embodiments of the present invention to produce diborane gas using boron halide and borohydride ionic liquid.

FIG. 2 is a schematic view of another system for process and composition embodiments of the present invention to produce diborane gas using liquid boron halide adduct and borohydride ionic liquid.

FIG. 3 is a schematic view of still another system for process and composition embodiments of the present invention to produce diborane gas using protic acid and borohydride ionic liquid.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

The embodiments described herein can be used to produce the diborane gas in a batch process.

Preferred embodiments of the current invention utilize low melting temperature borohydride salts that are liquids at less than about 212° F. (100° C.). These salts are classified as ionic liquids. The primary advantages of using ionic liquids when compared to the known processes include the ability to carry out a liquid phase reaction in the absence of an ether solvent, and the ability to process the reaction in the absence of solid byproducts.

The following are nonlimiting examples of borohydride ionic liquids which can be used with the present inventive embodiments:

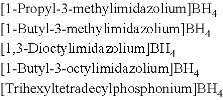

Ionic liquids generally comprise salts of alkylphosphonium, alkylammonium, N-alkylpyridinium or N,N′-dialkylimidazolium cations. Common cations contain C1 through C18 alkyl groups, and include the ethyl, propyl, butyl, hexyl, and octyl derivatives of N-alkyl-N′-methylimidazolium and N-alkylpyridinium. Other cations include pyridazinium, pyrimidinium, pyrazinium, pyrazolium, triazolium, thiazolium, and oxazolium. The borohydride salts comprising a cation that imparts a low melting temperature e.g., ionic liquids, are generically represented as [CAT]BH₄.

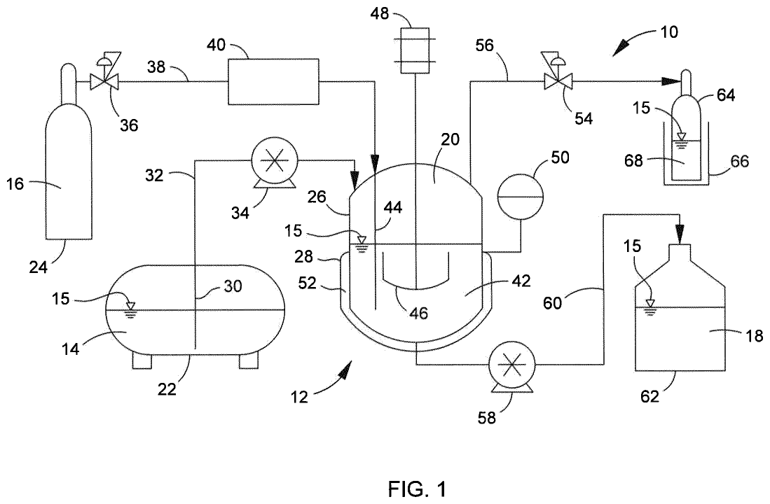

FIG. 1 shows first embodiments of a system 10 and a method according to the present invention. The system 10 includes a reaction device 12, a vessel 22 in which a supply of borohydride ionic liquid 14 is contained, and a liquid pump 34 for removing the borohydride ionic liquid from the vessel through a liquid supply line 32 and adding the borohydride ionic liquid to the reaction device through the liquid supply line. A gas-liquid interface within the vessel 22 and within other elements in FIG. 1 is shown at 15.

A cylinder 24 containing a supply of gaseous boron halide 16 is connected to a gas supply line 38 in which a pressure regulating valve 36 and a gas flow controller 40 are interposed for adding the gaseous boron halide to the reaction device 12. The gaseous boron halide 16 may be selected from the group consisting of boron trifluoride, boron trichloride, and boron tribromide.

The vessel 22 containing the supply of the borohydride ionic liquid 14 may be any container suitable for maintaining an inert environment that excludes ingress of air and moisture into the vessel. The reaction device 12 includes a reactor 26 or reactor vessel. The reaction device 12 also includes a cooling jacket 28 disposed about a portion or all of an exterior surface of the reactor 26. The reactor 26 may be charged with the borohydride ionic liquid 14 which is provided from the vessel 22 through the liquid supply line 32. An internal dip tube 30 is in fluid communication with the liquid supply line 32, such that one end of the internal dip tube is inserted into the borohydride ionic liquid 14 so that the liquid is drawn from the vessel 22 through the dip tube into the liquid supply line 32, wherein the borohydride ionic liquid is provided and metered through the liquid supply line into the reactor 26 by a liquid feed pump 34.

The gaseous boron halide 16 in the cylinder 24 is also provided to the reactor 26 through the gas supply line 38 in which the pressure regulating valve 36 and the gas flow controller 40 or flow meter is disposed. The gaseous boron halide 16 is provided or injected from the gas supply line 38 into an internal dip tube 44 connected therewith, and then to below a surface of a liquid reaction mixture 42 contained in the reactor 26. The liquid reaction mixture 42 may be agitated, continuously or otherwise, by a stirrer 46 disposed in the liquid reaction mixture and actuated by a motor 48. That is, the gaseous boron halide 16 from the cylinder 24 is mixed with the borohydride ionic liquid 14 from the vessel 22 in the reactor 26 for providing the liquid reaction mixture 42 as liquid that evolves or provides gaseous diborane. The agitating by the stirrer 46 facilitates the mixing of the liquid reaction mixture 42, and facilitates evolving and providing the gaseous diborane. A temperature of the liquid reaction mixture 42 is monitored by a temperature sensor 50 exposed to the liquid reaction mixture. The temperature of the liquid reaction mixture 42 is maintained within a desired temperature range by controlling a temperature and flow of a coolant 52 through the cooling jacket 28, and by adjusting a stir rate of the stirrer 46 via the motor 48, and by adjusting a rate of flow of the gaseous boron halide 16 added from the mass flow controller 40 to the reactor 26. The temperature range of the liquid reaction mixture 42 is maintained from 0° C. to 65° C. The cooling jacket 28 cools the exterior of the reactor 26 which in turn cools by conduction the contents of the reactor 26.

A pipeline 60 interconnects the reactor 26 with a vessel 62. A liquid pump 58 disposed in the pipeline 60 removes a portion as a liquid byproduct of the liquid reaction mixture 42 from the reactor 26 to another location, such as the vessel 62, wherein the liquid byproduct 18 is collected. There may be a small concentration of dissolved diborane in the liquid byproduct 18, but essentially all of the diborane will evolve into the gas phase described below.

A back pressure regulator 54 is disposed in a gaseous transfer line 56, the gaseous transfer line interconnecting a headspace 20 of the reactor 26 with a compressed gas cylinder 64. The compressed gas cylinder 64 may be evacuated prior to starting the process called for in this embodiment. The back pressure regulator 54 controls discharge of a gaseous diborane product from the headspace 20 of the reactor 26 into the compressed gas cylinder 64. The compressed gas cylinder 64 may be cooled, such as by cryogenic liquids, wherein the gaseous diborane product condenses such that a liquid diborane 68 is collected in the cylinder 64. Alternatively, a solid diborane product may be collected in the cylinder 64 if the temperature of the cylinder is sufficiently cryogenically cold enough. The melting point of diborane is −165° C. If the interior temperature of the cylinder 64 is less than −165° C., diborane would condense as a solid. The boiling point of diborane is −92° C. and therefore, a preferred upper temperature limit for the cylinder 64 should be −140° C.

In operation and referring to FIG. 1, a reaction occurs in the liquid reaction mixture 42 between the boron halide 16 and the borohydride ionic liquid 14. During this reaction, pressure in the reactor 26 is maintained within a desired range by the back pressure regulator 54. The desired range may include pressures below atmospheric pressure. As diborane is generated from the liquid reaction mixture 42, gaseous diborane is discharged from the headspace 20 through the gaseous transfer line 56 for collection in the compressed gas cylinder 64. The compressed gas cylinder 64 is disposed in a cryogenically cooled bath 66 such that the gaseous diborane is condensed into a liquid (or solid) diborane 68 in the cylinder 64. The liquid byproduct 18 of the reaction in the reactor 26 is discharged via the liquid transfer line 60 by a liquid transfer pump 58 into a byproduct collection vessel 62. It is possible that a small concentration of dissolved diborane is in the liquid byproduct 18, although substantially all of the diborane will evolve into the gas phase, without use of a solvent.

The embodiment of FIG. 1, especially the combination of the borohydride ionic liquid 14 (a liquid borohydride salt), the liquid reaction mixture 42 (a reaction mixture containing no solids), and the liquid byproduct 18 (a byproduct containing no solids) provides for the production of diborane from a pure borohydride ionic liquid 14 and the gaseous boron halide 16, thereby yielding a liquid salt byproduct. The nature of the reactants and products in these embodiments avoids processing of any solids and the inherent disadvantages associated with handling the solids.

The liquid reaction mixture 42, which has no volatile components other than diborane and residual BF₃, provides for relief of pressure at the end of the reaction at the back pressure regulator 54, and directly exposes the gas phase in the reactor 26 to be introduced into the gas cylinder 64. Residual diborane is allowed to fully condense into the gas cylinder 64.

In another embodiment, an ionic liquid borohydride, [CAT]BH₄, is selected to have a sufficiently low viscosity to allow the reaction to be carried out in the absence of any type of solvent or additive. As the reaction proceeds, a fluoroborate ionic liquid comprising the parent cation, [CAT]BF₄, is generated as a byproduct. Fluoroborate ionic liquids are generally reported to have much lower viscosities than their borohydride ionic liquid analogs. As such, the reaction mixture becomes less viscous as the reaction proceeds, which may impart improved processing properties. Fluoroborate ionic liquids are characterized by no or very low vapor pressures, which essentially eliminates the possibility for solvent contamination of the product during isolation. For example, the following formula is for the reaction of liquid 1-butyl-3-methylimidazolium borohydride, [BMIM]BH₄, with BF₃ gas:

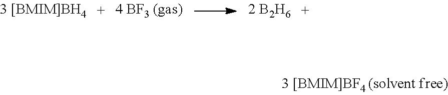

When carried out in a batch process, the steps for this first preferred embodiment of FIG. 1 are as follows: 1) gaseous BF₃ 16 is passed into a stirred reactor 26 containing neat [BMIM]BH₄ 14, 2) to minimize thermal decomposition of the diborane, the temperature of the reaction mixture 42 is maintained below about 95° F. (35° C.) by cooling, stir rate, and by adjusting the rate of BF₃ addition, 3) the diborane is passed into a refrigerated, compressed gas cylinder 64, where the diborane is condensed into a liquid 68 for subsequent processing, and 4) the fluoroborate liquid byproduct, [BMIM]BF₄ 18, resulting from the mixing in the reactor 26 is drained from the reactor for recycling, disposal, or to be processed for sale as a separate product.

In still another embodiment, BF₃ is introduced in the form of a liquid as a weakly complexed adduct of a fluoroborate ionic liquid, [CAT]B₂F₇ (alternatively denoted as [CAT]BF₄ BF₃). This embodiment allows the reaction to occur in a single phase, which provides more efficient mixing (mass transport) and better overall control of the reaction. This embodiment may provide an advantage over gaseous BF₃ for continuous processing, e.g., via plug flow or microscale flow chemistry. For example, the following formula is for the reaction of liquid [BMIM]BH₄ with liquid [BMIM]B₂F₇:

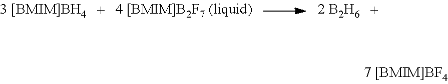

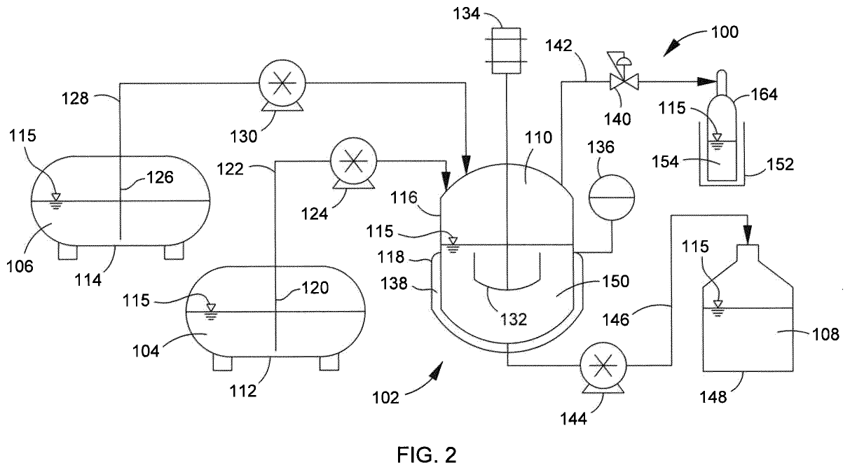

Referring to FIG. 2, there are shown other embodiments of a system 100 and a method according to the present invention. The system 100 includes a reaction device 102, a vessel 112 in which a supply of borohydride ionic liquid 104 is contained, and a liquid pump 124 for removing the borohydride ionic liquid from the vessel through a liquid supply line 122 and adding the borohydride ionic liquid to the reaction device through the liquid supply line. A gas-liquid interface within the vessel 112 and within other elements in FIG. 2 is shown at 115.

A vessel 114 containing a supply of liquid [CAT]B₂F₇ adduct 106 may be any container suitable for maintaining an inert environment that excludes ingress of air and moisture into the vessel. The vessel 114 is connected to a liquid supply line 128 in which a liquid flow controller 130 is interposed for adding the liquid [CAT]B₂F₇ adduct to the reaction device 102.

The reaction device 102 includes a reactor 116 or reactor vessel. The reaction device 102 also includes a cooling jacket 118 disposed about a portion or all of an exterior surface of the reactor 116. The reactor 116 may be charged with the borohydride ionic liquid 104 which is provided from the vessel 112 through the liquid supply line 122. An internal dip tube 120 is in fluid communication with the liquid supply line 122, such that one end of the internal dip tube is inserted into the borohydride ionic liquid 104 so that the liquid is drawn from the vessel 112 through the dip tube into the liquid supply line, wherein the borohydride ionic liquid is provided and metered through the liquid supply line into the reactor 116 by a liquid feed pump 124.

The liquid [CAT]B₂F₇ adduct 106 in the vessel 114 is also provided to the reactor 116 through the liquid supply line 128 in which the liquid flow controller 130 or flow meter is disposed. The liquid [CAT]B₂F₇ adduct 106 is provided or injected from the liquid supply line 128 into the reactor 116. A liquid reaction mixture 150 may be agitated, continuously or otherwise, by a stirrer 132 disposed in the liquid reaction mixture and actuated by a motor 134. That is, the liquid [CAT]B₂F₇ adduct 106 from the vessel 114 is mixed with the borohydride ionic liquid 104 from the vessel 112 in the reactor 116 for providing the liquid reaction mixture 150 as liquid that evolves or provides gaseous diborane. A temperature of the liquid reaction mixture 150 is monitored by a temperature sensor 136 exposed to the liquid reaction mixture. The temperature of the liquid reaction mixture 150 is maintained within a desired temperature range by controlling a temperature and flow of a coolant 138 through the cooling jacket 118, and by adjusting a stir rate of the stirrer 132 via the motor 134, and by adjusting a rate of flow of the liquid [CAT]B₂F₇ adduct 106 added from the flow controller 130 to the reactor 116. The temperature range of the liquid reaction mixture 150 is from 0° C. to 65° C. The cooling jacket 118 cools the exterior of the reactor 116 which in turn cools by conduction the contents of the reactor 116.

A pipeline 146 interconnects the reactor 116 with a vessel 148. A liquid pump 144 disposed in the pipeline 146 removes the liquid reaction mixture 150 from the reactor 116 to a another location, such as the vessel 148, wherein a portion as a liquid byproduct 108 is collected. It is possible that a small concentration of dissolved diborane is in the liquid byproduct 108, although substantially all of the diborane will evolve into the gas phase, without use of a solvent.

A back pressure regulator 140 is disposed in a gaseous transfer line 142, the gaseous transfer line interconnecting a headspace 110 of the reactor 116 with a compressed gas cylinder 164. The compressed gas cylinder 164 may be evacuated prior to starting the process called for in this embodiment. The back pressure regulator 140 is disposed in the gaseous transfer line 142 upstream of the compressed gas cylinder 164 and controls discharge of a gaseous diborane product from the headspace 110 of the reactor 116 into the compressed gas cylinder 164. The compressed gas cylinder 164 may be cooled, such as by cryogenic liquids, wherein the gaseous diborane product condenses such that a liquid diborane 154 is collected in the cylinder 164. Alternatively, a solid diborane product may be collected in the cylinder 164 if the temperature of the cylinder is sufficiently cryogenically cold enough.

In operation and referring to FIG. 2, a reaction occurs in the liquid reaction mixture 150 between BF₃ from the liquid [CAT]B₂F₇ adduct 106 and the borohydride ionic liquid 104. During this reaction, pressure in the reactor 116 is maintained within a desired range by the back pressure regulator 140. The desired range may include pressures below atmospheric pressure. As diborane is generated from the liquid reaction mixture 150, gaseous diborane is discharged from the headspace 110 through the gaseous transfer line 142 for collection in the compressed gas cylinder 164. The compressed gas cylinder 164 is disposed in a cryogenically cooled bath 152 such that the gaseous diborane is condensed into a liquid (or solid) diborane 154 in the compressed gas cylinder. The liquid byproduct 108 of the reaction in the reactor 116 is discharged via the liquid transfer line 146 by a liquid transfer pump 144 into a byproduct collection vessel 148.

The embodiment of FIG. 2, especially the combination of the borohydride ionic liquid 104 (a liquid borohydride salt), the liquid reaction mixture 150 (a reaction mixture containing no solids), and the liquid byproduct 108 (a byproduct containing no solids) provides for the production of diborane from a pure borohydride ionic liquid 104 salt and the liquid [CAT]B₂F₇ adduct 106 yielding only liquid phase byproducts. The nature of the reactants and products avoids the necessity of using solvents for processing, and avoids the inherent disadvantages associated with using and handling the solvents.

When carried out in a batch process, the steps for this second embodiment in FIG. 2 are as follows: 1) liquid [CAT]B₂F₇ adduct 126 is transferred into a stirred reactor 116 containing neat [BMIM]BH₄ 104, 2) to minimize thermal decomposition of the diborane, the temperature of the reaction mixture 150 is maintained below about 95° F. (35° C.) by cooling, stir rate, and by adjusting the rate of liquid [CAT]B₂F₇ adduct addition, 3) the diborane is passed into a refrigerated, compressed gas cylinder 164, where the diborane is condensed into a liquid 154 for subsequent processing, and 4) the fluoroborate byproduct, [BMIM]BF₄ 108 is drained from the reactor 116 for recycling, disposal, or to be processed for sale as a separate product.

Further embodiments may include incorporating one or more additives to improve processing, reaction rate, and/or reaction yield. Additives may be used to modulate viscosity, improve heat transfer, reduce the melting temperature of borohydride salts, catalyze the reaction, etc. Nonlimiting examples of additives include ionic liquids comprising a fluoroborate anion (BF₄), alkali metal salts like sodium chloride and potassium chloride, borate esters like trimethyl borate and triethyl borate, covalent polar liquids like diethyl ether and diglyme, and covalent hydrocarbon liquids like hexane and toluene.

Liquids such as either of diethyl ether and diglyme may catalyze the reaction between [M]BH₄ and BF₃ via formation of borate ester intermediates. Sub-stoichiometric quantities of ether materials may be used as additives for this purpose.

Borohydride salts, [CAT]BH₄, that have a melting point higher than the optimal reaction temperature may still be used but may require one or more additives to yield a liquid phase mixture at the desired temperature. Small additive quantities may be used to depress the melting point by taking advantage of colligative properties. Although preferred embodiments of the invention are solvent free, in some embodiments a solvent may be added to yield a liquid phase solution of a higher melting or higher viscosity borohydride salt. The process still retains the advantage of generating a homogeneous, liquid phase byproduct [CAT]BF₄ salt.

Any combination of neat or additive-containing [CAT]BH₄ ionic liquid or low melting temperature salt with gaseous BF₃ or a weakly complexed liquid phase adduct of BF₃ can be used. Other boron halides such as gaseous BCl₃, liquid BCI₃, gaseous BBr₃, liquid BBr₃, and weakly complexed liquid phase adducts of each of BCI₃ and BBr₃ can be used as alternatives to BF₃.

An alternative protic acid route does not require a boron halide gas like BF₃ or BCI₃. In these alternative embodiments a borohydride ionic liquid, [CAT]BH₄, is reacted with a protic acid, H [A], to generate diborane. The byproducts are hydrogen gas and a salt comprising the cation of the starting borohydride ionic liquid, [CAT]+, and the anion of the protic acid, [A]−. The byproduct salt, [CAT][A], may be an ionic liquid depending on the cation/anion combination:

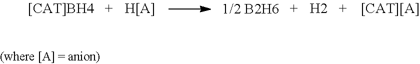

The acid, H [A], can be selected from any number of protic acids. The following are nonlimiting examples of protic acids applicable to the present inventive embodiments: sulfuric acid, methanesulfonic acid, phosphoric acids, hydrogen chloride, carboxylic acids, fluorinated acids, and other organic and mineral acids. The acid can be delivered in the gas phase, as a pure liquid or solid, or as a solution or other mixture.

The [CAT]BH₄ ionic liquid can be used in pure form or with an additive to enhance reactivity, reduce viscosity, and/or lower the melting point i.e., by taking advantage of colligative properties.

A representative combination of reactants for generating diborane using the protic acid route is 1-butyl-3-methylimidazolium borohydride, [BMIM]BH4, and 85% orthophosphoric acid:

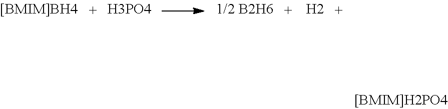

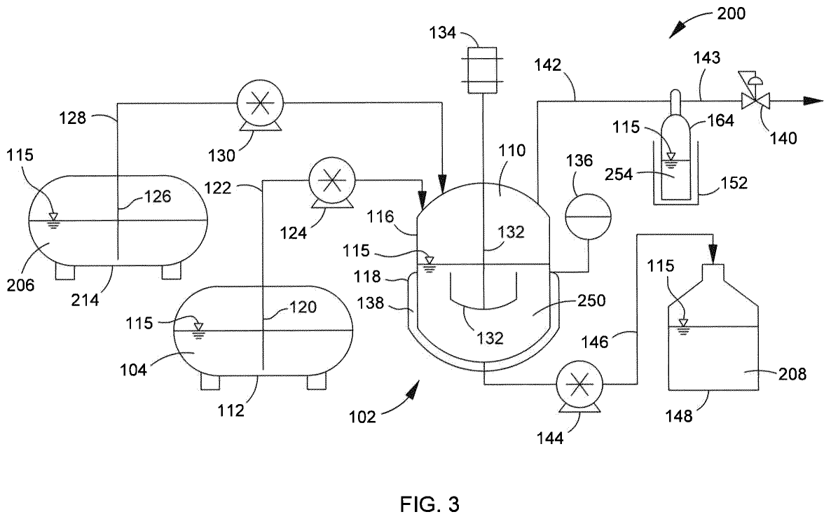

Referring to FIG. 3, many elements of the embodiments shown in FIG. 3 are similar to those of FIG. 2, although in FIG. 3 a system 200 includes a vessel 214 that holds or contains instead protic acid 206. Certain other elements shown in FIG. 3 are different from those shown in FIG. 2.

The system 200 includes a reaction device 102, a vessel 112 in which a supply of borohydride ionic liquid 104 is contained, and a liquid pump 124 for removing the borohydride ionic liquid from the vessel through a liquid supply line 122 and adding the borohydride ionic liquid to the reaction device 102 through the liquid supply line. A gas-liquid interface within the vessel 112 and within other elements in FIG. 3 is shown at 115.

The vessel 214 containing a supply of the protic acid 206 may be any container suitable for maintaining an inert environment that excludes ingress of air and moisture into the vessel. The vessel 214 is connected to a liquid supply line 128 in which a liquid flow controller 130 is interposed for adding the protic acid 206 to the reaction device 102.

The reaction device 102 includes a reactor 116 or reactor vessel. The reaction device 102 also includes a cooling jacket 118 disposed about a portion or all of an exterior surface of the reactor 116. The reactor 116 may be charged with the borohydride ionic liquid 104 which is provided from the vessel 112 through the liquid supply line 122. An internal dip tube 120 is in fluid communication with the liquid supply line 122, such that one end of the internal dip tube is inserted into the borohydride ionic liquid 104 so that the liquid is drawn from the vessel 112 through the dip tube into the liquid supply line, wherein the borohydride ionic liquid is provided and metered through the liquid supply line into the reactor 116 by a liquid feed pump 124.

The protic acid 206 in the vessel 214 is also provided to the reactor 116 through the liquid supply line 128 in which the liquid flow controller 130 or flow meter is disposed. The protic acid 206 is provided or injected from the liquid supply line 128 into the reactor 116. A liquid reaction mixture 250 may be agitated, continuously or otherwise, in the reactor 116 by a stirrer 132 disposed in the liquid reaction mixture and actuated by a motor 134. That is, the protic acid 206 from the vessel 214 is mixed with the borohydride ionic liquid 104 from the vessel 112 in the reactor 116 for providing the liquid reaction mixture 250 as liquid that evolves or provides gaseous diborane. A temperature of the liquid reaction mixture 250 is monitored by a temperature sensor 136 exposed to the liquid reaction mixture. The temperature of the liquid reaction mixture 250 is maintained within a desired temperature range by controlling a temperature and flow of a coolant 138 through the cooling jacket 118, and by adjusting a stir rate of the stirrer 132 via the motor 134, and by adjusting a rate of flow of the protic acid 206 added from the flow controller 130 to the reactor 116. The temperature range of the liquid reaction mixture 250 is from 0° C. to 65° C. The cooling jacket 118 cools the exterior of the reactor 116 which in turn cools by conduction the contents of the reactor 116.

A pipeline 146 interconnects the reactor 116 with a vessel 148. A liquid pump 144 disposed in the pipeline 146 removes the liquid reaction mixture 250 from the reactor 116 to a another location, such as the vessel 148, wherein a portion as a liquid byproduct 208 is collected. It is possible that a small concentration of dissolved diborane is in the liquid byproduct 208, although substantially all of the diborane will evolve into the gas phase, without use of a solvent.

A gaseous transfer line 142 interconnects a headspace 110 of the reactor 116 with a compressed gas cylinder 164. The compressed gas cylinder 164 may be evacuated prior to starting the process called for in this embodiment. A pipeline 143 is also connected to an outlet of the compressed gas cylinder 164 and extends to subsequent processing such as a vacuum or a scrubber (not shown). A back pressure regulator 140 is disposed in the pipeline 143 downstream of the compressed gas cylinder 164 for controlling the buildup of gaseous hydrogen which occurs with this embodiment. That is, the process and mixture of the protic acid with the borohydride ionic liquid will produce gaseous diborane and hydrogen including gaseous hydrogen in the cylinder 164. Since hydrogen does not condense under the operating conditions of this embodiment, the hydrogen must be vented or evacuated from the cylinder 164. Hence, the back pressure regulator 140 disposed in the pipeline 143 to vent the hydrogen from the cylinder 164.

The compressed gas cylinder 164 may also be cooled, such as by cryogenic liquids, wherein the gaseous diborane product condenses such that a liquid diborane 254 is collected in the cylinder 164. Alternatively, a solid diborane product may be collected in the cylinder 164 if the temperature of the cylinder is sufficiently cryogenically cold enough.

In operation and referring to FIG. 3, a reaction occurs in the liquid reaction mixture 250 between the protic acid 206 and the borohydride ionic liquid 104. During this reaction, pressure in the reactor 116 is maintained within a desired range by the back pressure regulator 140. The desired range may include pressures below atmospheric pressure. As diborane is generated from the liquid reaction mixture 250, gaseous diborane is discharged from the headspace 110 through the gaseous transfer line 142 for collection in the compressed gas cylinder 164. The compressed gas cylinder 164 is disposed in a cryogenically cooled bath 152 such that the gaseous diborane is condensed into a liquid (or solid) diborane 254 in the compressed gas cylinder. Hydrogen produced in the cylinder 164 is vented through pipeline 143. The liquid byproduct 208 of the reaction in the reactor 116 is discharged via the liquid transfer line 146 by a liquid transfer pump 144 into a byproduct collection vessel 148.

The embodiment of FIG. 3, especially the combination of the borohydride ionic liquid 104 (a liquid borohydride salt), the liquid reaction mixture 250 (a reaction mixture containing no solids), and the liquid byproduct 208 (a byproduct containing no solids) provides for the production of diborane from a pure borohydride ionic liquid 104 salt and the protic acid 206 yielding only liquid phase byproducts. The nature of the reactants and products avoids the necessity of using solvents for processing, and avoids the inherent disadvantages associated with using and handling the solvents.

When carried out in a batch process, the steps for this third preferred embodiment in FIG. 3 are as follows: 1) liquid protic acid [A]H 206 is transferred into a stirred reactor 116 containing neat [BMIM]BH₄ 104, 2) to minimize thermal decomposition of the diborane, the temperature of the reaction mixture 250 is maintained below about 95° F. (35° C.) by cooling, stir rate, and by adjusting the rate of protic acid 206 addition, 3) the diborane is passed into a refrigerated, compressed gas cylinder 164, where the diborane is condensed into a liquid 254 for subsequent processing, and 4) the reaction byproduct, [BMIM][A] 208 is drained from the reactor 116 for recycling, disposal, or to be processed for sale as a separate product.

Further embodiments may include incorporating one or more additives to improve processing, reaction rate, and/or reaction yield. Additives may be used to modulate viscosity, improve heat transfer, reduce the melting temperature of borohydride salts, catalyze the reaction, etc. Nonlimiting examples of additives include ionic liquids comprising a fluoroborate anion (BF₄), alkali metal salts like sodium chloride and potassium chloride, covalent polar liquids like diethyl ether and diglyme, and covalent hydrocarbon liquids like hexane and toluene.

Borohydride salts, [CAT]BH₄, that have a melting point higher than the optimal reaction temperature may still be used but may require one or more additives to yield a liquid phase mixture at the desired temperature. Small additive quantities may be used to depress the melting point by taking advantage of colligative properties. Although preferred embodiments of the invention are solvent free, in some embodiments a solvent may be added to yield a liquid phase solution of a higher melting or higher viscosity borohydride salt. The process still retains the advantage of generating a homogeneous, liquid phase byproduct [BMIM][A]salt.

Any combination of neat or additive-containing [CAT]BH₄ ionic liquid or low melting temperature salt with a suitable protic acid can be used.

With respect to the embodiments shown in FIGS. 1, 2 and 3, and in addition to batch processing, manufacturing can be carried out using continuous processes, including semi-batch, continuous stirred tank, plug flow, microscale flow chemistry, etc. Manufacturing can be campaigned (started and stopped), semi-continuous, continuous, on demand, etc. Systems may be configured to provide on-site, on demand delivery of diborane in such a way as to minimize the instantaneous inventory of diborane gas. An advantage of using the present fully homogeneous liquid phase system (i.e., with liquid reactants, liquid reaction mixtures, and liquid products) is that on-site, on-demand delivery is more feasible for producing diborane than are known heterogeneous systems.

The process used to isolate and purify B₂H₆ may be selected from condensation at cryogenic temperatures (e.g., cryotrapping), adsorption, filtration, distillation, compression, etc. Any of the known methods to isolate and purify diborane may be applied.

The invention includes the following embodiments described above with respect to FIGS. 1-3.

A process embodiment one for producing diborane, which includes mixing boron halide with borohydride ionic liquid for providing a liquid reaction mixture, the liquid reaction mixture chemically reacting for producing gaseous diborane.

The process embodiment one, wherein the borohydride ionic liquid can be selected from the group consisting of [1-Propyl-3-methylimidazolium]BH₄,
[1-Butyl-3-methylimidazolium]BH₄,
[1,3-Dioctylimidazolium]BH₄,
[1-Butyl-3-octylimidazolium]BH₄, and
[Trihexyltetradecylphosphonium]BH₄.

The process embodiment one, wherein the mixing occurs without solvents.

The process embodiment one, wherein the mixing avoids generating solid byproducts.

The process embodiment one, wherein the borohydride ionic liquid includes a melting temperature less than 100° C.

The process embodiment one, further including cooling the liquid reaction mixture.

The process embodiment one, further including agitating the liquid reaction mixture.

The process embodiment one, further including maintaining a temperature of the liquid reaction mixture, the temperature in a range of from 0° C. to 65° C.

The process embodiment one, further including removing a byproduct of the liquid reaction mixture to another location for collecting dissolved diborane from the byproduct at the another location.

The process embodiment one, further including removing the gaseous diborane to another location.

The process of the immediate previous embodiment, further including cooling the gaseous diborane at the another location, wherein the cooling is sufficient to condense the gaseous diborane into liquid diborane or optionally into solid diborane.

The process of the immediate previous embodiment, wherein the cooling is by a cryogenic liquid.

The process embodiment one, wherein the boron halide is selected from the group consisting of gaseous boron trifluoride, gaseous boron trichloride, and gaseous boron tribromide.

The process embodiment one, wherein the boron halide includes a liquid selected from the group consisting of liquid boron trichloride and liquid boron tribromide.

The process embodiment one, wherein the boron halide includes a liquid boron trifluoride adduct of a fluoroborate ionic liquid.

A process embodiment two for producing diborane, which includes mixing protic acid with borohydride ionic liquid for providing a liquid reaction mixture, the liquid reaction mixture chemically reacting for producing gaseous diborane.

The process of the immediate previous embodiment, wherein the producing further includes producing hydrogen.

The process of the immediate previous embodiment, further including controlling buildup of gaseous hydrogen during the producing of the gaseous hydrogen.

The process embodiment two, further including removing a byproduct of the liquid reaction mixture to another location for collecting dissolved diborane from the byproduct at the another location.

A composition embodiment one for producing diborane, wherein the composition embodiment one includes boron halide and borohydride ionic liquid. The composition embodiment one, wherein the composition embodiment one includes 4 molar equivalents of boron halide to 3 molar equivalents of borohydride ionic liquid.

A composition embodiment two for producing diborane, wherein the composition embodiment two includes liquid boron halide adduct and borohydride ionic liquid. The composition embodiment two, wherein the composition embodiment two includes 4 molar equivalents of liquid boron halide adduct to 3 molar equivalents of borohydride ionic liquid.

A composition embodiment three for producing diborane, wherein the composition embodiment three includes protic acid and borohydride ionic liquid. The composition embodiment three, wherein the composition embodiment three includes 1 molar equivalent of reactive protic acid to 1 molar equivalent of borohydride ionic liquid.

It will be understood that the embodiments described herein are merely exemplary, and that a person skilled in the art may make variations and modifications without departing from the spirit and scope of the invention. All such variations and modifications are intended to be included within the scope of the invention as provided for in the appended claims. It should be understood that the embodiments described above are not only in the alternative but can be combined.

What is claimed is:

1. A process for producing diborane, comprising:
mixing boron halide with borohydride ionic liquid for providing a liquid reaction mixture, the liquid reaction mixture chemically reacting for producing gaseous diborane.

2. The process of claim 1, wherein the borohydride ionic liquid can be selected from the group consisting of [1-Propyl-3-methylimidazolium]BH₄, [1-Butyl-3-methylimidazolium]BH₄, [1,3-Dioctylimidazolium]BH₄, [1-Butyl-3-octylimidazolium]BH₄, and [Trihexyltetradecylphosphonium]BH₄.

3. The process of claim 1, wherein the mixing occurs without solvents.

4. The process of claim 1, wherein the mixing avoids generating solid byproducts.

5. The process of claim 1, wherein the borohydride ionic liquid comprises a melting temperature less than 100° C.

6. The process of claim 1, further comprising cooling the liquid reaction mixture.

7. The process of claim 1, further comprising agitating the liquid reaction mixture.

8. The process of claim 1, further comprising maintaining a temperature of the liquid reaction mixture, the temperature in a range of from 0° C. to 65° C.

9. The process of claim 1, further comprising removing a byproduct of the liquid reaction mixture to another location for collecting dissolved diborane from the byproduct at the another location.

10. The process of claim 1, further comprising removing the gaseous diborane to another location.

11. The process of claim 10, further comprising cooling the gaseous diborane at the another location, wherein the cooling is sufficient to condense the gaseous diborane into liquid diborane or optionally into solid diborane.

12. The process of claim 11, wherein the cooling is by a cryogenic liquid.

13. The process of claim 1, wherein the boron halide is selected from the group consisting of gaseous boron trifluoride, gaseous boron trichloride, and gaseous boron tribromide.

14. The process of claim 1, wherein the boron halide comprises a liquid selected from the group consisting of liquid boron trichloride and liquid boron tribromide.

15. The process of claim 1, wherein the boron halide comprises a liquid boron trifluoride adduct of a fluoroborate ionic liquid.

16. A process for producing diborane, comprising:
mixing protic acid with borohydride ionic liquid for providing a liquid reaction mixture, the liquid reaction mixture chemically reacting for producing gaseous diborane.

17. The process of claim 16, wherein the producing further comprises producing hydrogen.

18. The process of claim 17, further comprising controlling buildup of gaseous hydrogen during the producing of the gaseous hydrogen.

19. The process of claim 16 further comprising removing a byproduct of the liquid reaction mixture to another location for collecting dissolved diborane from the byproduct at the another location.

20. A composition for producing diborane, comprising boron halide and borohydride ionic liquid.

21. The composition of claim 20, comprising 4 molar equivalents of boron halide to 3 molar equivalents of borohydride ionic liquid.

22. A composition for producing diborane, comprising liquid boron halide adduct and borohydride ionic liquid.

23. The composition of claim 22, comprising 4 molar equivalents of liquid boron halide adduct to 3 molar equivalents of borohydride ionic liquid.

24. A composition for producing diborane, comprising protic acid and borohydride ionic liquid.

25. The composition of claim 24, comprising 1 molar equivalent of reactive protic acid to 1 molar equivalent of borohydride ionic liquid.
